(19) United States
(12) Patent Application Publication
(10) Pub. No.: US 2003/0202433 A1
(43) Pub. Date: Oct. 30, 2003

(54) Method of compensating for variations in track pitches of optical discs

(75) Inventor: Il-Kweon Joung, Ansan-si (KR)

Correspondence Address: MORGAN LEWIS & BOCKIUS LLP, 1111 PENNSYLVANIA AVENUE NW, WASHINGTON, DC, 20004, US

(73) Assignee: Samsung Electro-Mechanics Co., Ltd.

(21) Appl. No.: 10/335,156

(22) Filed: Jan. 2, 2003

(30) Foreign Application Priority Data
Apr. 26, 2002 (KR) 2002-23094

(51) Int. Cl. G11B 7/085

(52) U.S. Cl. 369/30.17; 369/30.14; 369/44.28

(57) ABSTRACT

Disclosed herein is a method of compensating for variations in the track pitches of optical discs. The method includes the step of activating a focus servo and inactivating a tracking servo so as not to trace the tracks of the optical disc. Thereafter, the pickup assembly is transferred across the optical disc to generate the traverse signal caused by differences between the amounts of light reflected by the tracks of the optical disc and the other portions of the optical disc. The traverse signal is shaped into a pulse wave, and the number of pulses of the traverse signal is counted. The rotation number of the optical disc is measured and stored. The track pitch of the rotating optical disc is calculated. Finally, a target track number is calculated, and a seek operation is performed.

### BACKGROUND OF THE INVENTION

1. Field of the Invention

The present invention relates generally to a method of compensating for variations in track pitches of optical discs, and more particularly to a method of compensating for variations in track pitches of optical discs, which is capable of greatly reducing seek time that is an important performance factor for various data processing apparatuses using optical pickups.

2. Description of the Prior Art

Generally, in data processing apparatuses, such as a Compact Disc (CD) drive, a Digital Versatile Disc (DVD) drive, a Compact Disc-ReWritable (CD-RW) drive and the like, the operation of reading or writing data is carried out by devices called “optical pickups”.

In order to read data at a desired location on an optical disc, a pickup assembly is transferred to the desired location where the data exist, and the data are read by the pickup assembly. Time required to read the data is called seek time. The performance of various kinds of apparatuses having pickup assemblies is dependent upon the seek speed at which data are sought.

Hitherto, when data are read or written using an optical pickup in a conventional data processing apparatus, a pickup assembly has to be transferred across the tracks of an optical disc so as to reach a desired location of the optical disc where data exist, so a target value to control the transfer of the pickup assembly is calculated by a target track number. Thereafter, when the pickup assembly is transferred, a control signal corresponding to the target track number is generated and the transfer of the pickup assembly is carried out in response to the generated control signal corresponding to the target track number.

As shown in FIG. 1, a track pitch of an optical disc is generally set to a fixed standard value according to the kinds of optical disk. In general, a target track number is calculated using the fixed standard track pitch, and a control signal used to transfer a pickup assembly is generated on the basis of the calculated target track number.

However, various kinds of currently marketed optical discs have various track pitches different from a standard track pitch, so errors would occur if a target track number is calculated on the basis of a fixed standard track pitch. Additionally, seek performance would deteriorate in the case of non-standard optical discs.

### SUMMARY OF THE INVENTION

Accordingly, the present invention has been made keeping in mind the above problems occurring in the prior art, and an object of the present invention is to provide a method of compensating for variations in track pitches of optical discs, which is capable of compensating for variations in the track pitches of optical discs by measuring the track pitches of optical discs and calculating target track numbers using the measured track pitches.

In order to accomplish the above object, the present invention provides a method of compensating for variations in the track pitches of optical discs in a data processing apparatus using an optical pickup, comprising the steps of: while a pickup assembly is transferred, activating a focus servo to trace tracks of an optical disc and generate a traverse signal, and inactivating a tracking servo so as not to trace the tracks of the optical disc; while the optical disc is rotated, transferring the pickup assembly across the optical disc to generate the traverse signal caused by differences between the amounts of light reflected by the tracks of the optical disc and the other portions of the optical disc; shaping the traverse signal into a pulse wave, and counting the number of pulses of the traverse signal; measuring and storing the rotation number of the optical disc while the pickup assembly is transferred to measure a track pitch; calculating the track pitch of the rotating optical disc using the measured number of pulses of the traverse signal and the actual distance the pickup assembly is transferred; and calculating a target track number using the calculated track pitch, and performing a seek operation using the calculated target track number.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is an example view illustrating a track pitch of an optical disc;

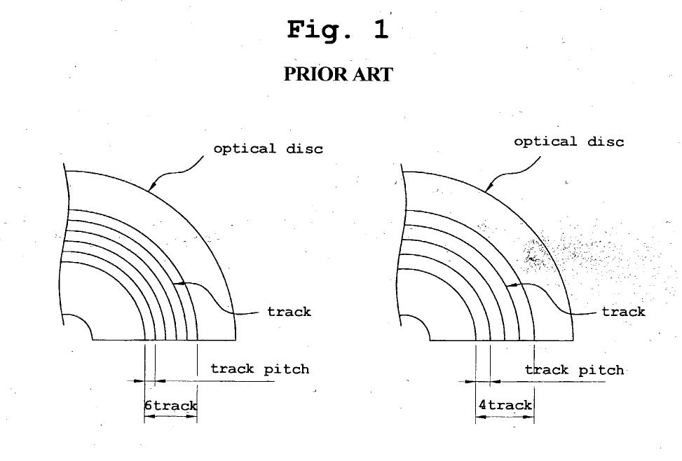

FIG. 2 is a block diagram schematically showing a data processing apparatus using an optical pickup in accordance with the present invention;

FIG. 3 is an example diagram illustrating a traverse signal in accordance with the present invention; and

FIG. 4 is a flowchart illustrating a method of compensating for variations in the track pitches of optical discs in accordance with the present invention.

### DESCRIPTION OF THE PREFERRED EMBODIMENTS

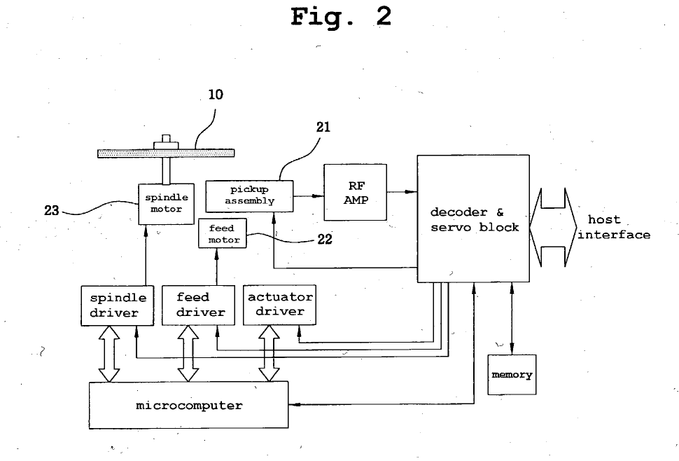

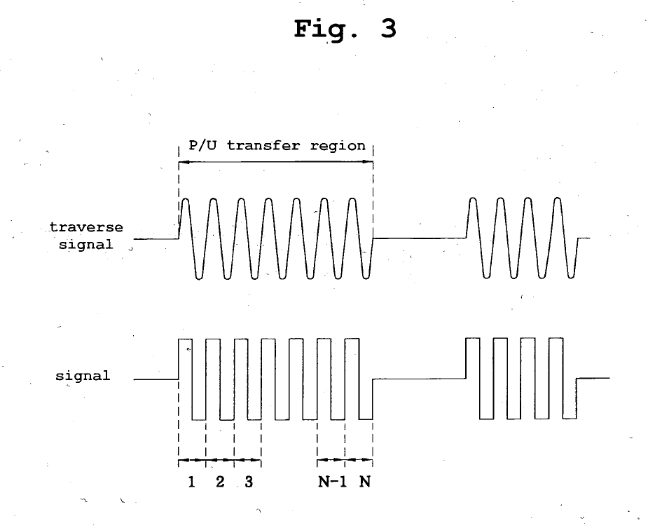

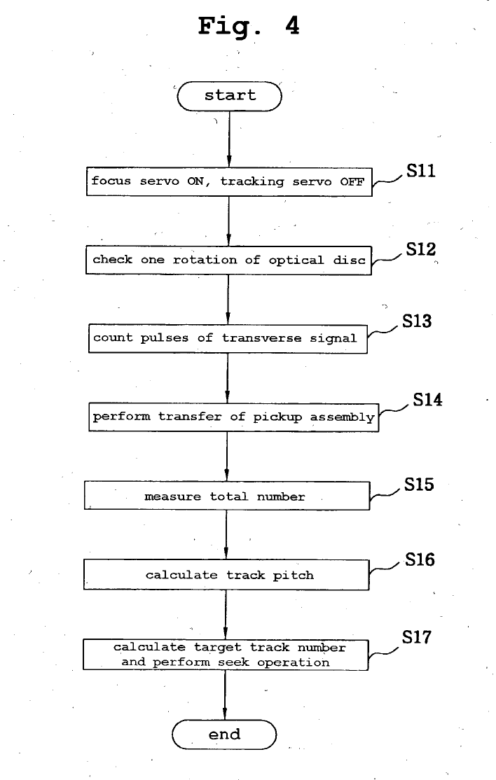

In the accompanying drawings, FIG. 2 is a block diagram schematically showing a data processing apparatus using an optical pickup in accordance with the present invention, FIG. 3 is an example diagram illustrating a traverse signal in accordance with the present invention, and FIG. 4 is a flowchart illustrating a method of compensating for variations in the track pitches of optical discs in accordance with the present invention.

As shown in FIG. 2, in a data processing apparatus using an optical pickup, in order to read data stored in an optical disc 10, a pickup assembly 21 is transferred a certain distance and an actual distance the pickup assembly 21 is transferred is calculated, thereby measuring a track pitch of the optical disc 10.

Generally, in such a data processing apparatus, a feed motor 22, as shown in FIG. 2, is used to transfer the pickup assembly 21, so an actual distance the pickup assembly 21 is transferred can be calculated with the specifications of such a speed motor taken into consideration.

As described above, FIG. 4 is a flow chart illustrating a method of compensating for variations in the track pitches of optical discs. When the pickup assembly 21 is transferred, a pickup assembly servo activates a focus servo to trace the tracks of the optical disc 10 and generate a traverse signal while inactivating a tracking servo so as not to trace the tracks of the optical disc 10 at step S11.

If the pickup assembly 21 is transferred while the optical disc 10 is rotated, the pickup assembly 21 crosses the rotating optical disc 10, so the pickup assembly 21 transverses the tracks of the optical disc 10 at step S12. In this case, the tracking servo is inactivated, and thus does not trace the tracks of the optical disc 10. Meanwhile, the focus servo is activated, and thus generates a traverse signal shown in FIG. 3 that is caused by the difference between the amounts of light reflected by the tracks of the optical disc 10 and the other portions of the optical disc 10.

Referring to FIG. 3, it is understood that a pulse of the traverse signal is generated whenever the pickup assembly 21 traverses one track. That is, when the traverse signal is shaped into a pulse wave and the number of pulses of the traverse signal is counted at step S13, the number of the tracks of the optical disc 10, which the pickup assembly 21 has traversed, are known. While the pickup assembly 21 is transferred to measure the track pitch at step S14, the rotation number of the optical disc 10 is simultaneously measured and stored in a memory at step S15.

The track pitch P of the optical disc 10 can be obtained using the measured number of pulses of the traverse signal N_{T} and the actual distance S the pickup assembly 21 is transferred at step S16. A conventional target track is calculated using the obtained track pitch, and then a seek operation is carried out at step S17. In such a case, the precision of the measurement of the track pitch is dependent on the transfer speed of the pickup assembly 21 and the rotational speed of the optical disc 10. Accordingly, it is preferable that the rotational speed of the optical disc 10 be as low as possible.

If the transfer speed of the pickup assembly 21 becomes fast, the frequency of the traverse signal becomes high and the high frequency affects the counting of the number of pulses. Therefore, the transfer speed of the pickup assembly 21 is preferably controlled so that the traverse signal has a appropriate frequency suitable for circumstances in which the system is situated.

One more point that should be taken into consideration is the eccentricity of the optical disc 10 which varies with different optical discs.

The tracks storing data are formed on the optical disc 10 in a spiral form. The deviation of the center of the tracks from the physical rotation center of the optical disc 10 is called the eccentricity in this specification.

In the optical disc 10 having such eccentricity, although the pickup assembly 21, which reads data from the tracks of the optical disc 10 while the optical disc 10 is rotated, remains stationary on the optical disc 10, the center of the tracks deviates from the physical rotation center of the optical disc 10. Accordingly, from the point of view of the pickup, the tracks are vibrated while the optical disc 10 is rotated. From the point of view of the pickup, the amount of vibration of the rotating optical disc 10 can vary with the amount of the eccentricity of the optical disc 10.

Also, the vibration of the tracks is reflected by the traverse signal that is used to measure the track pitch. Accordingly, a component of the traverse signal caused by the eccentricity of an optical disc has to be eliminated in order to minimize error in measuring the track pitch.

The method of measuring the component of the traverse signal caused by the eccentricity of optical disc 10 is as follows.

First, the pickup assembly servo activates the focus servo to trace the tracks of the optical disc 10 and generate a traverse signal, and inactivates the tracking servo so as not to trace the tracks of the optical disc 10. Additionally, the pickup assembly servo inactivates a feed servo to allow the pickup assembly 21 to remain stationary.

Thereafter, the rotation number of the optical disc R is measured and the number of pulses of the traverse signal N_{E} is counted as described above. In this case, the numbers of pulses of the traverse signal N_{E}, which is generated per a single rotation of the optical disc 10, results from the eccentricity of the optical disc 10.

Accordingly, the exact number of pulses can be obtained by extracting a value obtained by multiplying the number of pulses of the traverse signal N_{E} resulting from the eccentricity of the optical disc 10 and the rotation number of the optical disc R measured and stored in the memory while the track pitch is measured, from the number of pulses of the traverse signal NT counted while the track pitch is measured.

$$\frac{S}{{N}_{T} - R \cdot {N}_{E}} = P \qquad [ Equation 1 ]$$

Where P is a track pitch, N_{T} is the total number of pulses of the traverse signal, N_{E} is the number of pulses of the traverse signal resulting from the eccentricity of an optical disc, R is the rotation number of the optical disc, and S is the actual distance the pickup assembly 21 is transferred.

An exact track pitch P of a currently rotating optical disk can be finally obtained by performing a calculation using the number of pulses of the traverse signal and the actual distance the pickup assembly 21 is transferred.

When an operation is carried out in which the pickup assembly 21 is transferred to a desired location to read data using a finally calculated track pitch P, the finally calculated track pitch P is applied to an algorithm that calculates a target track number. As a result, the target track number can be obtained for an optical disc that has a track pitch different from a fixed standard track pitch, allowing the pickup assembly to be accurately transferred to a desired location where desired data exist.

As described above, in accordance with the method of the present invention, the variations in the track pitches of optical discs can be compensated for, allowing pickup assemblies of data processing apparatuses to be accurately transferred to desired locations where desired data exist, regardless of the track pitches of optical discs.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A method of compensating for variations in the track pitches of optical discs in a data processing apparatus using an optical pickup, comprising the steps of:
activating a focus servo to trace tracks of an optical disc and generate a traverse signal, and inactivating a tracking servo so as not to trace the tracks of the optical disc, while a pickup assembly is transferred;
transferring the pickup assembly across the optical disc to generate the traverse signal caused by differences between the amounts of light reflected by the tracks of the optical disc and the other portions of the optical disc, while the optical disc is rotated;
shaping the traverse signal into a pulse wave, and counting the number of pulses of the traverse signal;
measuring and storing the rotation number of the optical disc while the pickup assembly is transferred to measure a track pitch;
calculating the track pitch of the rotating optical disc using the measured number of pulses of the traverse signal and the actual distance the pickup assembly is transferred; and
calculating a target track number using the calculated track pitch, and performing a seek operation using the calculated target track number.

2. The method according to claim 1, wherein the track pitch is calculated using the following equation,
$$\frac{S}{{N}_{T} - R \cdot {N}_{E}} = P$$
where P is the track pitch, N_{T} is the total number of pulses of the traverse signal, N_{E} is the number of pulses of the traverse signal resulting from eccentricity of the optical disc, R is the rotation number of the optical disc, and S is a actual distance the pickup assembly is transferred.
